(19) United States
(12) Patent Application Publication
(10) Pub. No.: US 2005/0239500 A1
(43) Pub. Date: Oct. 27, 2005

(54) Method and apparatus for dual mode mobile handset

(76) Inventors: Haixian Liu, Alameda, CA (US); Yanbin Yu, Fremont, CA (US); William X. Huang, San Ramon, CA (US); Liming Gao, Alameda, CA (US)

Correspondence Address: FELIX L. FISCHER, ATTORNEY AT LAW, 1607 MISSION DRIVE, SUITE 204, SOLVANG, CA, 93463, US

(21) Appl. No.: 10/818,644

(22) Filed: Apr. 5, 2004

(51) Int. Cl. H04Q 7/20

(52) U.S. Cl. 455/553.1; 455/557

(57) ABSTRACT

A dual mode mobile handset provides a single set of RF circuit elements which interface with a single set of analog circuit elements thereby reducing redundancy in the system. A DSP connected to the analog circuit elements modulates and demodulates both modes of transmission signals with software elements and pre and post processes the standard signals employing embedded softward. A single control CPU provides data to and receives data from the DSP for selected processing as the first standard transmission signal or the second standard transmission signal.

### FIELD OF THE INVENTION

This invention relates generally to the field of mobile phone handsets and, more particularly, to mobile phones employing a single set of RF, analog and other hardware components with pre and post processing to implement two wireless communication standards.

### BACKGROUND OF THE INVENTION

Mobile phones have been developed based on numerous standards including both analog and digital communications capability. Most current cellular phones operate with digital capability; however, multiple standards have proliferated for digital mobile phone system technology including GSM and CDMA. PHS technology for telecommunications systems is gaining in popularity in emerging markets for primary infrastructure development. However, to avoid carrying multiple mobile phones to also have capability to communicate with current cellular phone standards, it is desirable for a PHS user to have a single mobile handset that also includes standard cellular mobile communications technology such as GSM or CDMA.

Current handsets accommodate this requirement by providing dedicated hardware circuitry for both the PHS and cellular standards. This requires significant duplication of hardware elements and is a costly and complex solution.

It is therefore desirable to have a mobile phone system that employs one set of RF, analog and other hardware components to support both PHS and a cellular mobile phone standard.

It is also desirable to provide software elements of the system which can be modified to accommodate differing cellular mobile standards.

### SUMMARY OF THE INVENTION

A dual mode mobile handset as defined by the present invention employs a single set of RF circuit elements which interface with a single set of analog circuit elements thereby reducing redundancy in the system. A DSP is connected to the analog circuit elements and has first system software elements for modulating and demodulating a first standard transmission signal and software for pre-processing data for modulation as the first standard transmission signal and post-processing data demodulated from the first standard transmission signal. The DSP has second system software elements for modulating and demodulating a second standard transmission signal and software for pre-processing data for modulation as the second standard transmission signal and post-processing data demodulated from the second standard transmission signal. A single control CPU provides data to and receives data from the DSP for selected processing as the first standard transmission signal or the second standard transmission signal.

### BRIEF DESCRIPTION OF THE DRAWINGS

These and other features and advantages of the present invention will be better understood by reference to the following detailed description when considered in connection with the accompanying drawings wherein:

FIG. 1 is a block diagram of the hardware elements of a handset employing the present invention;

FIG. 2 is a timeline demonstrating GSM and PHS communication windows; and

FIG. 3 is a block diagram of the functional elements of the handset.

### DETAILED DESCRIPTION OF THE INVENTION

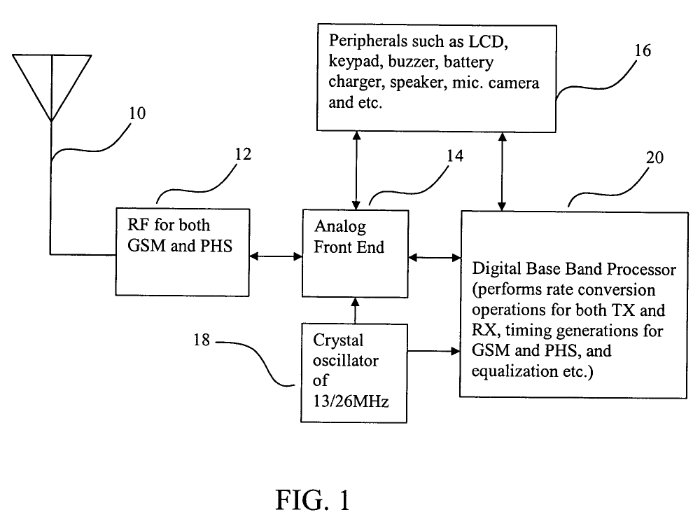

Referring to the drawings, a handset employing a GSM hardware chipset is disclosed. As shown in FIG. 1, a single RF transmission system is employed with a common antenna 10 and RF components 12 which are interconnected to an Analog Front End (AFE) 14. The AFE provides an interface to peripheral devices on the handset such as the liquid crystal display (LCD), keypad, buzzer, battery charger, speaker, microphone, camera and other standard features, generally identified jointly as 16. A single crystal oscillator 18 provides clocking for the system as will be described in greater detail subsequently. A digital baseband processing system 20 provides numerical processing capability for rate conversion operations for both transmit and receive operations, timing generation for GSM and PHS signal standards, and equalization, etc.

The RF components in an exemplary embodiment comprise a Low Noise Amplifier (LNA), Mixer, Amplifier, RF Signal Generator, and Filters. The RF components for the embodiment are comparable to a GSM EDGE system, with the addition of one frequency band for the necessary PHS frequencies. The functions of the RF components are to convert the base band signals into RF signal and to convert RF signal into baseband signals. For the transmission path, the RF components can convert almost any baseband signal into a RF signal. For the recevie path, the RF components can receive any signal with similar bandwidth and the same frequency.

When the dual mode (GSM/PHS) mobile phone system is receiving and transmitting in GSM mode, a normal GSM signal path can be applied.

Signal modulation for the GSM standard employs two modes; GMSK and 8 PSK. The modulation scheme for PHS is p/4 DQPSK. 8 PSK and p/4 DQPSK have very similar characteristics with both having amplitude and phase changes. However, the coefficients of raising cosine shaping filter for PHS are quite different from the requirements for a GSM filter. Also, the symbol rates are 192 KHz and 270.8333 KHz for PHS and GSM, respectively. To maximize the similarities, a GSM chipset with 8 PSK capability is therefore employed in the embodiment shown and accommodation for the varying symbol rates is made by the digital signal processor as described subsequently.

To compensate for filtering and symbol rate differences, the transmit signal for a PHS transmission is generated by the DSP and software/firmware rather than by the built-in circuit for the GSM modulation. The analog portion of the GSM chipset receives a compatible signal for the 13 MHz system such as 0.8125 MHz. (13 MHz/16). To avoid incurring high processing requirements, the PHS signal is generated in two steps. The first step is to manipulate the I and Q data by applying the raising cosine and up-sampling filter which is implemented by the DSP and software. The signal of 0.203125 MHz is up-sampled 4 times to 0.8125 MHz. After up-sampling, a scaling filter of a small number of taps, implemented in exemplary embodiments with a polyphase filter, is applied to convert the symbol rate to the 192 KHz of PHS signal standard frequency. After conversion of the symbol rate, a built-in and hard wired up-sampling filter such as a Cascaded Averaging Filter (CAF) is applied to convert the signal into 6.5 MHz and forwarded to the RF circuit.

Upon activation of a call the receive path for an incoming PHS transmission employs a similar two-step procedure. The received signal is first up-scaled 2 times (i.e. from 270.833 KHz to 541.6 KHz). A scaling filter with 3-4 taps is applied to convert this signal to a 384 KHz signal. The other receiving operations such as equalization, slicing and de-mapper and de-scrambling are applied on the domain of n*192 KHz. (where n is an integer).

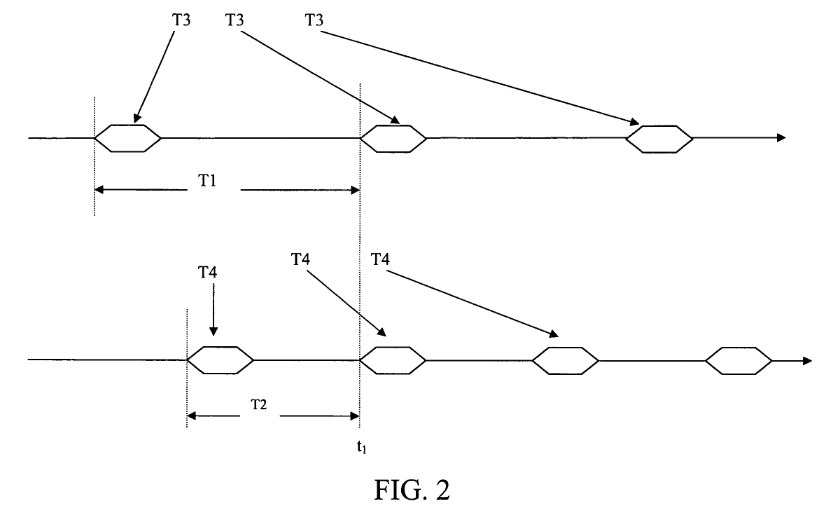

In the stand-by mode, i.e. listening mode, both GSM and PHS mode can be activated and communicate with base station periodically. As shown in FIG. 2, the periods of such communication, T1 and T2, are both long enough and communication times, T3 and T4, are small enough that the probability of both GSM and PHS systems activating at the same time will be small. If a conflict occurs, as shown at time t₁ one mode is provided with higher priority creating a skip of the other mode during the interference period. This priority is preprogrammed or may be programmed alternatively based on network availability. As the result, an incoming phone call from either GSM or PHS base-station will not be missed.

In the talking mode, only one mode is activated. During operation in one mode, an incoming phone call from the other system will not be connected. The base-station will consider the handset has lost wireless connection and handset will be informed of the dropped call later when the current phone call is finished.

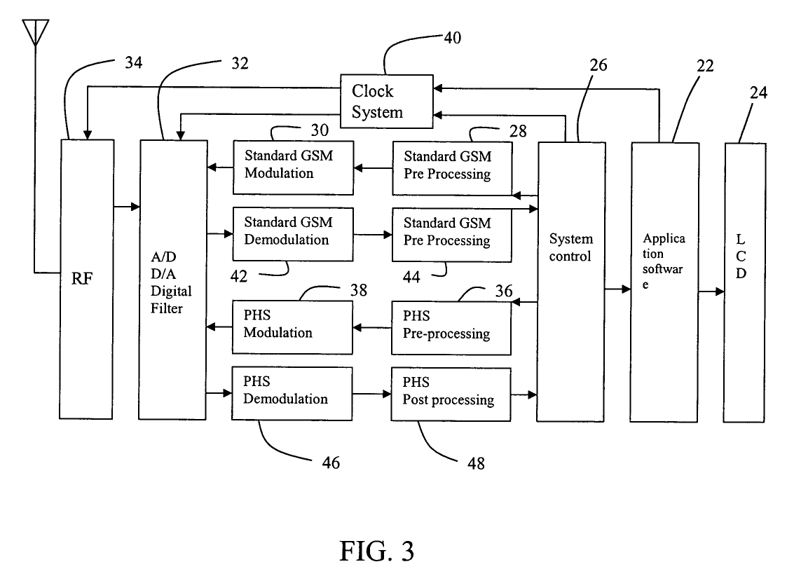

As shown in FIG. 3, functional operation of the system employing the present invention uses the capabilities of the programmable capabilities of the CPU in the handset and the DSP. For a transmission from the handset, the application software 22 interfaces with the LCD 24 for communication to the user based on inputs from the system control 26. System control also defines the call type PHS or GSM and prompts the appropriate software in the DSP. For a GSM call, data is provided through the GSM pre-process 28 to the modulation elements of the GSM modulation & demodulation 30 and is passed to the D/A portion of the analog circuit elements 32 and the RF circuits 34 for transmission through the antenna. For the embodiment as described above, this constitutes the standard functioning of the normal GSM signal path.

For a PHS call, the system control provides the data through the PHS pre-process 36 in which filtering is performed to compensate for any distortion to the whole transmit data-path. After completion of the pre-processing, the data is provided to the PHS modulation elements 38 to convert the binary data into an IQ signal and further convert the IQ signal into an RF frequency. The data is then passed to the D/A portion of the analog circuit elements 32 for conversion prior to passing to the RF circuit 34 for transmission through the antenna.

For receiving a GSM transmission, the RF circuit passes the signal to the A/D and digital filtering portions of the analog circuit elements and through the demodulation elements 42 and post processing elements 44 of the GSM software in the DSP, again operating in the standard GSM mode of the system.

For receiving a PHS transmission, the RF circuit passes the signal to the A/D and digital filtering portions of the analog circuit elements and through the PHS demodulation elements 46 of the software in the DSP. The de-modulation converts the RF signal into an IQ signal and which is then converted into binary data. The demodulated signal is then passed to the PHS Post-Process 48 for equalization, slicing and de-mapper, and de-scrambling. A single clock system 40 provides clocking for the elements of both the PHS and GSM system.

Having now described the invention in detail as required by the patent statutes, those skilled in the art will recognize modifications and substitutions to the specific embodiments disclosed herein. Such modifications are within the scope and intent of the present invention as defined in the following claims.

1. A dual mode mobile handset comprising:
a single set of RF circuit elements;
a single set of analog circuit elements connected to the RF circuit elements;
a DSP connected to the analog circuit elements and having
first system elements including
means for modulating and demodulating a first standard transmission signal;
means for pre-processing data for modulation as the first standard transmission signal and post-processing data demodulated from the first standard transmission signal;
second system elements including
means for modulating and demodulating a second standard transmission signal;
means for pre-processing data for modulation as the second standard transmission signal and post-processing data demodulated from the second standard transmission signal;
a single control means providing data to and receiving data from the DSP for selected processing as the first standard transmission signal or the second standard transmission signal.

2. A dual mode mobile handset as defined in claim 1 further comprising a single clock system connected to the analog circuit elements and RF circuit elements and responsive to the control means.

3. A dual mode mobile handset as defined in claim 1 wherein the handset provides simultaneous standby for the first and second transmission signal by activation of the system elements for the first and second transmission signals in a time division multiplexed manner.

4. A dual mode mobile handset as defined in claim 3 wherein a first period associated with the time division multiplexing for the first transmission signals differs from a second period associated with the time division multiplexing for the second transmission signals, and wherein communication blocks for the first transmission signals and second transmission signals are substantially shorter than the first period and second period, and a priority of operation of the first and second system elements is predetermined for any overlap of the communication blocks.

5. A method for implementing dual transmission and receiving modes in a handset comprising the steps of:
providing a single set of RF circuit elements;
connecting a single set of analog circuit elements to the RF circuit elements;
connecting a DSP to the analog circuit elements and for a first mode
pre-processing data for modulation as a first standard transmission signal;
modulating the first standard transmission signal to be provided to the analog circuit elements for transmission;
demodulating a first standard transmission signal received from the analog circuit elements; and
post-processing data demodulated from the first standard transmission signal;
and for a second mode
pre-processing data for modulation as a second standard transmission signal;
modulating the second standard transmission signal to be provided to the analog circuit elements for transmission;
demodulating a second standard transmission signal received from the analog circuit elements; and
post-processing data demodulated from the second standard transmission signal;
providing data to and receiving data from the DSP in a single control means for selected processing as the first standard transmission signal or the second standard transmission signal.

6. A method for implementing dual transmission and receiving modes in a handset as defined in claim 5 wherein the first mode is GSM and the second mode is PHS.

7. A method for implementing dual transmission and receiving modes in a handset as defined in claim 6 wherein the step of modulating the second standard transmission signal includes the steps of:
manipulating I and Q data by applying a raising cosine to create a signal of 13 MHz/n where n is an integer;
applying an up-sampling filter to the created signal for upsampling m times where m is an integer no greater than n;
applying a scaling filter of a small number of taps to convert the symbol rate to the 192 KHz of PHS signal standard frequency; and
applying a second up-sampling filter to convert the signal to 13 Mhz/p where p equals m-n.

8. A method for implementing dual transmission and receiving modes in a handset as defined in claim 7 wherein m equals 16 and n equals 4.

9. A method for implementing dual transmission and receiving modes in a handset as defined in claim 7 wherein the scaling filter is a polyphase filter.

10. A method for implementing dual transmission and receiving modes in a handset as defined in claim 7 wherein the second up-scaling filter is a Cascaded Averaging Filter.

11. A method for implementing dual transmission and receiving modes in a handset as defined in claim 6 wherein the step of demodulating the second standard transmission signal comprises the steps of:
up-scaling the signal;
applying a scaling filter convert the up-scaled signal to a signal of n*192 KHz; and the step of post processing comprises the steps of:
equalizing, slicing and de-mapping and de-scrambling which are applied on a domain of n*192 KHz.

12. A method for implementing dual transmission and receiving modes in a handset as defined in claim 11 where up-scaling is a factor of 2 and the scaling filter is a 3-4 tap filter resulting in n equaling 2.
